(19) United States
(12) Patent Application Publication
(10) Pub. No.: US 2025/0040738 A1
(43) Pub. Date: Feb. 6, 2025

(54) Island Mat

(71) Applicant: Vishnu Vardhan Chakravaram, Gallatin, TN (US)

(72) Inventor: Vishnu Vardhan Chakravaram, Gallatin, TN (US)

(73) Assignee: Vishnu Vardhan Chakravaram, Gallatin, TN (US)

(21) Appl. No.: 18/907,569

(22) Filed: Oct. 6, 2024

Related U.S. Application Data
(60) Provisional application No. 63/530,976, filed on Aug. 6, 2023.

(51) Int. Cl. A47G 23/03

(52) U.S. Cl. CPC A47G 23/0303; A47G 23/0316

(57) ABSTRACT

The Island Mat is used to prevent various surfaces to take strains due to spilled food or liquid or any other type of substances. The Island mat is placed on the kitchen island on which an island tower is placed which is then used by the baby to stand on it while eating food.

### CROSS-REFERENCE TO RELATED APPLICATIONS

This application Takes the Benefit of Provisional Application No. 63/530,976 filed on Aug. 6, 2023.

### STATEMENT REGARDING FEDERALLY SPONSORED RESEARCH OR DEVELOPMENT

N/A

### THE NAMES OF THE PARTIES TO A JOINT RESEARCH AGREEMENT

### Incorporation-by-Reference of Material Submitted on a Compact Disc or as a Text File Via the Office Electronic Filing System (EFS-Web)

N/A

### STATEMENT REGARDING PRIOR DISCLOSURES BY THE INVENTOR OR A JOINT INVENTOR

N/A

### BACKGROUND OF THE INVENTION

### (1) Field of the Invention

This Invention is related to baby products. To be more specific this invention pertains to mat that can be placed on the kitchen island like surface. When a toddler eats food standing on the food gets spilled all over the Island surface, on the side wall of the Island and also on the floor. Hence the need for a mat that can cover all the three surfaces.

### (2) Description of Related Art Including Information Disclosed Under 37 CFR 1.97 and 1.98

### BRIEF SUMMARY OF THE INVENTION

In one embodiment composite structure is an Island Mat, wherein the Island mat is fitted with a suction cup on the bottom side of the composite structure and this embodiment is used to stick the Island mat to the Island top surface.

In another embodiment composite structure is an Island mat, wherein the Island mat is fitted with a Velcro on the bottom side of the composite structure and this embodiment is used to stick the Island mat to the Island top surface.

To Illustrate the versatility the composite structure can be installed on a surface when the kid is having food or playing with water or any other activity that involves with spilling of liquids or semi solids or solids that are way too small. The composite structure can be configured for maraid of usages. For example, the composite structure can be sued to cover the surface of the island, wall and floor.

The various embodiments enable, support and/or provide a new paradigm in the field of mechanical products. The embodiments disclose an Island mat, which enables the user with an easy and effortless act of containing spillage on the kitchen island surface, sidewall of the Island and also the floor at the same time. For example, the user can place the island mat on the kitchen island top surface to cover the island top surface and roll the mat to the side wall of the island and to the floor.

### BRIEF DESCRIPTION OF THE SEVERAL VIEWS OF THE DRAWING(S)

FIG. 1A shows an illustrative isometric top view of Island mat the present invention in use;

FIG. 1B shows an illustrative isometric bottom view of Island mat the present invention in use;

FIG. 2 shows an illustrative isometric top view of the Island mat assembly that includes suction cups of the present invention in use;

FIG. 3 shows an illustrative isometric bottom view of the Island mat assembly that includes Velcro of present invention in use;

FIG. 4A shows an illustrative isometric view of the island mat assembly that is folded of the present invention in use;

FIG. 4B shows an illustrative Isometric view of the island mat assembly that is folded of the present invention in use

FIG. 5 show an illustrative isometric view of the kitchen assembly of the present invention in use.

### DETAILED DESCRIPTION OF THE INVENTION

The invention will be primarily described within the context of embodiment; however, those skilled in the art and informed by the reaching there in will realize that the invention is also applicable to other technical areas and/or embodiments. Practitioners skilled in the art will recognize numerous other embodiments as well.

The illustrative embodiment described here in are not meant to be limiting. It maybe readily understood that certain aspects of the disclosed embodiment can be arranged and combined in a variety of different configuration, all of which are contemplated herein.

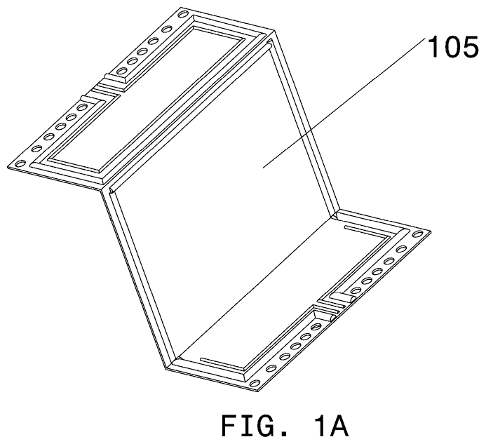

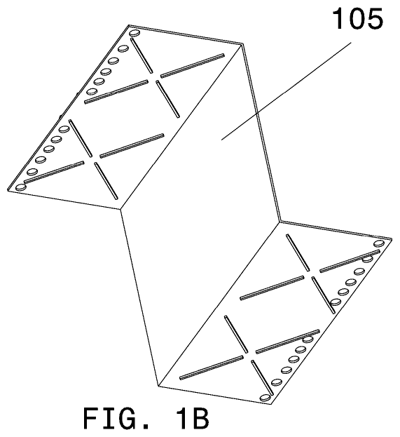

FIG. 1A depicts isometric top view of an exemplary island mat 105, according to the embodiment of the composite structure. The composite structure 105, can be primarily used as mat for the island surface, side wall of the island and the floor. User places the island mat on the top surface of the island on the side where the user prefers. After user places the island mat on the kitchen island surface, mat takes the shape of letter Z from the side. The composite structure 105 has series of holes on both short sides of the mat which creates a provision for cleaning the mat by hanging it. The composite structure 105 has two sets of rectangular walls that are of different sizes and height, but both with a channel, small rectangular wall is located inside the bigger rectangular wall to prevent liquid over flow from the mat.

FIG. 1B depicts isometric bottom view of an exemplary island mat 105. according to the embodiment of the composite structure. The ribs in the share of the letter X are present to prevent the Island mat slip from the smooth surface on the kitchen Island.

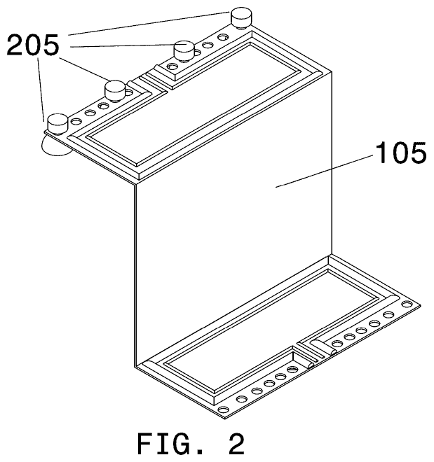

FIG. 2 depicts isometric top view of an exemplary island mat assembly 200. The composite structure preferably consists of 2 major segments namely (1) island mat 105, (2) Suction cups 205. The composite structure 105 can stay in place on the kitchen island with the use of suction cups 205.

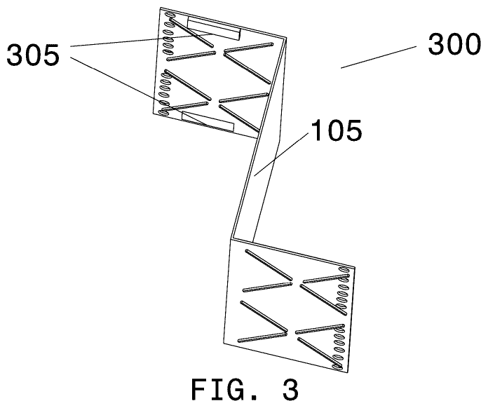

FIG. 3 depicts isometric bottom view of an exemplary island mat assembly 300. The composite structure preferably consists of 2 major segments namely, (1) Island mat 105, (2) Velcro 305. The composite structure 105 can stay in place on the kitchen island with the use of Velcro strap 305 sticked to the island mat 105. The counter part of Velcro 305 sticked to the kitchen island 515.

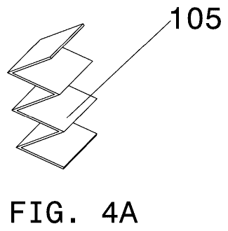

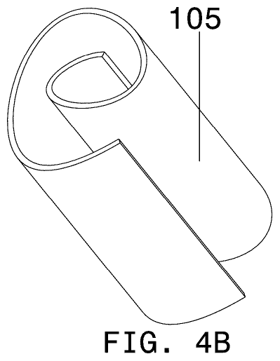

FIG. 4A depicts isometric view of an exemplary island mat 105. The composite structure 105 can be folded across it vertical length and horizontal breadth for storage and portability.

FIG. 4B depicts isometric view of an exemplary island mat 105 which can be rolled across its vertical length. The composite structure 105, can be folded on its horizontal breadth before rolling for storage and portability.

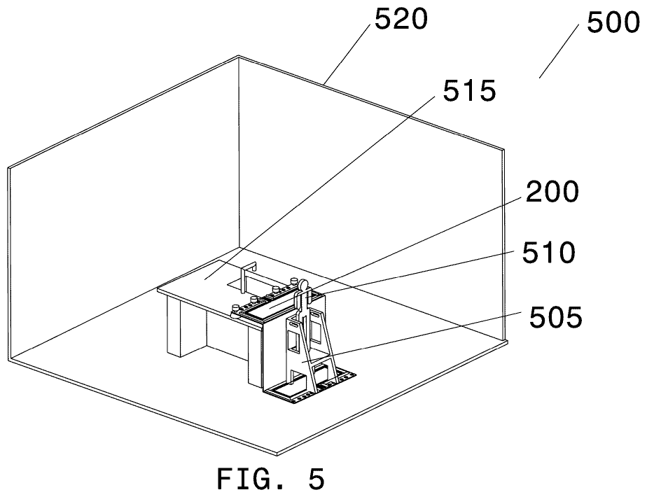

FIG. 5 depicts isometric view of an exemplary kitchen assembly 500. The kitchen assembly preferably consists of 5 major segments (1) Island tower 505, (2) Baby 510, (3) Island mat assembly 200, (4) Island 515, (5) kitchen 520. The composite structure 200 is placed on Island 515, an Island tower 505 is placed on the bottom portion on the composite structure assembly 200, on the Island tower 505 stand baby 510 for playing or eating food or engaging in any other activity.

1. A Composite Structure which is an Island Mat comprising:
A rectangular flat sheet with considerable thickness;
The said rectangular flat sheet with considerable thickness has series of holes on either sides that are short;
The said rectangular flat sheet with considerable thickness has two rectangular walls one inside the other with a opening on its long side;
The said rectangular walls one inside another, wherein the outside rectangle has taller wall than the inside rectangle;
The said rectangular flat sheet with considerable thickness has two sets of rectangular walls one inside the other on either sides of the said rectangular flat sheet but located only on the top;
The said rectangular flat sheet with considerable thickness has two ribs that form the shape of the letter X;
The said ribs that from the shape of the letter X are located on either sides of the said rectangular flat sheet but only on the bottom to prevent slipping of the said island mat.

2. The Composite structure as described in claim-1 can be hanged for cleaning to the shower curtain rod using the said holes and rings present on the said shower curtain rod.

3. The Composite structure as described in claim-1 used to cover island in the kitchen, its side wall and the floor while baby is eating food, playing with liquids or any other activity that involves with spillage.

4. The Composite structure as described in claim-1 said rectangular walls one inside the other prevent liquids from flowing to the floor or said kitchen island.

5. The Composite structure as described in claim-4 said rectangular walls one inside the other has a small outlet to let the liquids exist the said island mat out into the kitchen sink.

6. The Composite structure as described in claim-1 can be assembled with suction cups to the said holes which can be used to fix the position of the said Island mat when placed on the said kitchen island.

7. The Composite structure as described in claim-1 can be assembled with Velcro to bottom side which can be used to fix the position of the said Island mat when placed on the said kitchen Island.

8. The Composite structure as described in claim-1 is made of food graded material or nontoxic or BPA free.

9. The Composite structure as described in claim-1 can be rolled by folding in half on its longer length and can be folded multiple times on its side and has a strap to contain when the said island mat is rolled and is portable.

10. The Composite structure as described in claim-1 is used to prevent stains on the said kitchen island surface, side wall and the floor.

11. The Composite structure as described in claim-1 is made of heat-resistant material to with said hot containers when placed on it and prevents marks caused by the said hot containers on the surface of the said kitchen island surface.

12. The Composite structure as described in claim-1 can be used as a play mat, outdoor mat or a camping mat.

13. The Composite structure as described in claim-1 is made on material that is smooth which makes it easy to remove sticky food or another substance and any suction mechanism involved containers such as plate or tumbler can be placed on the said island mat.

14. The Composite structure as described in claim-1 can be rotated 360 deg on the top side.

15. The Composite structure as described in claim-1 when placed on the kitchen island curves on the side of the said kitchen island to prevent cracks to form due to weight.
